(19) United States
(12) Patent Application Publication
(10) Pub. No.: US 2024/0385017 A1
(43) Pub. Date: Nov. 21, 2024

(54) METHOD FOR DETERMINING A FLOW RATE, FLOW SENSOR, AND MEASURING SYSTEM COMPRISING A FLOW SENSOR

(71) Applicant: IMT ANALYTICS AG, Buchs SG (CH)

(72) Inventors: Matthias VAN DER STAAY, Obstalden (CH); Matthias BINDER, Buchs (CH)

(73) Assignee: IMT ANALYTICS AG, Buchs, SG (CH)

(21) Appl. No.: 18/579,057

(22) PCT Filed: Jun. 29, 2022
(86) PCT No.: PCT/IB2022/056064

§ 371 Date: Jan. 12, 2024

(30) Foreign Application Priority Data
Jul. 12, 2021 (EP) 21185104.3

(51) Int. Cl. G01F 1/40

(52) U.S. Cl. CPC G01F 1/40

(57) ABSTRACT

A method for determining a flow rate of a fluid through a flow sensor having a measurement channel. The method comprises the steps of steps: a. providing a fluid in the measuring channel of the flow sensor; b. detecting at least one first differential pressure in a first differential pressure region in the measurement channel; c. detecting at least one second differential pressure in a second differential pressure region in the measurement channel, and the differential pressure in the second differential pressure region encompasses the differential pressure in the first differential pressure region; d. transmitting the detected differential pressures to an evaluation unit; and e. determining a flow rate in the measurement channel with the evaluation unit on the basis of the detected differential pressures. Further described are a flow sensor and a measuring system.

This application is a National Stage completion of PCT/IB2022/056064 filed Jun. 29, 2022, which claims priority to European patent application serial no. 21185104.3 filed Jul. 12, 2021.

### FIELD OF THE INVENTION

The invention relates to a method for determining a flow rate of a fluid by a flow sensor having a measurement channel, a flow sensor, a measurement system having a flow sensor, and a differential pressure sensor.

### BACKGROUND OF THE INVENTION

Flow measurements are used in a wide range of applications, including respirators, inhalers, oxygen concentrators and anaesthesia machines. There are various measurement approaches: Pressure-based, thermal measurement, ultrasonic approaches or variable-area flow measurements.

Most pressure-based approaches use the relationship between pressure and flow rate. In a venturi meter, the flow channel is made smaller, causing the flow velocity in the channel to change. This in turn creates a pressure difference between the fast and slow flow areas. The resulting differential pressure between the fast and slow flow areas is now flow dependent. Thus, the flow rate can be derived from the measured differential pressure. An alternative approach is to insert a resistance into the flow channel. In doing so, a certain amount of the pressure falls across the resistance. Thus, there is a pressure difference upstream and downstream of the resistance, which in turn is flow-dependent. This differential pressure is measured to determine the flow rate. There are various ways in which such a resistance can be constructed. For example, an orifice plate can be used as a resistance. Other flow measurements use strainers, honeycomb elements or linear flow elements as resistance.

Each resistance or differential pressure is composed of two parts, a laminar part and a turbulent part. The laminar part has a linear relationship between the flow rate and the differential pressure in the measurement channel, while the turbulent part has a quadratic relationship between the flow rate and the differential pressure.

U.S. Pat. No. 6,681,189A discloses a computerized method for determining a flow rate of a fluid flowing through a conduit having an obstruction flow meter, comprising: Receiving a beta ratio value indicative of a beta ratio of the obstruction flow meter; Receiving a pressure difference value indicative of a pressure difference across the obstruction flow meter; Receiving a density value indicative of a density of the fluid; Receiving a discharge coefficient formula for the obstruction flow meter, the discharge coefficient formula being a function of the beta ratio of the obstruction flow meter and an Euler number for the fluid flowing through the conduit; and Determining the flow rate by the computer based on the received beta ratio value, the received pressure difference value, the received density value, and the received discharge coefficient formula.

CN212340332U discloses a method for reducing interference of high precision flow meters. The measuring device comprises a measuring tube with a plurality of pressure rings arranged in series, between which two differential pressure sensors are arranged, whereby two mutually adjacent pressures between the adjacent pressure rings are measured with the aid of the differential pressure sensors.

US2002/016688A1 discloses a method for accurately calculating the gas and liquid mass flows in an extended venturi tube, comprising the use of four values determined through testing: ΔP3 which is the measured pressure differential across the venturi contraction; ΔP2 which is the measured pressure differential across the extended venturi throat; P which is the absolute pressure upstream from the venturi, and T which is the temperature of the upstream flow.

The disadvantage of these known solutions is that only a limited flow measurement range can be recorded, which is also known as the turndown ratio. The turndown ratio is calculated by dividing the maximum measurable flow rate by the minimum measurable flow rate, and thus characterises the range capability of a flow measurement.

### SUMMARY OF THE INVENTION

It is therefore the objective of the present invention to create a method which avoids at least one of the aforementioned disadvantages and, in particular, to provide an improved method, an improved flow sensor or an improved measurement system with which an evaluation of the flow rate over a higher flow measurement range with an improved absolute resolution and measurement accuracy is possible. Furthermore, a differential pressure sensor is to be provided with which several differential pressure ranges can be measured simultaneously with improved resolution.

The objective is achieved by the features of the independent claims. Advantageous further developments are set out in the figures and in the dependent patent claims.

According to the method of the invention for determining a flow rate of a fluid through a flow sensor having a measurement channel, the method comprises at least the following steps:
Providing a fluid in the measurement channel of the flow sensor;
Sensing at least one first (or inner) differential pressure in the measurement channel, wherein the at least one first differential pressure is present in a first differential pressure range in the measurement channel;
Detecting at least one second (or outer) differential pressure in the measurement channel, wherein the at least one second differential pressure is present in a second differential pressure range in the measurement channel and the differential pressure in the second differential pressure range encompasses the differential pressure in the first differential pressure range;
Transmitting the detected differential pressures to an evaluation unit;
Determining a flow rate in the measurement channel with the aid of the evaluation unit on the basis of the detected differential pressures.

The fluid is typically a gas or a liquid. In particular, the flow sensor can be used for testing the flow rate of the respiratory gas (as a fluid) through a respirator. A differential pressure in the measurement channel is created by means of at least one resistive element in the measurement channel, since due to the resistive element a first pressure is present on a first side of the resistive element in the measurement channel and a second pressure is present on a second side of the resistive element. A differential pressure is created by sensing the two pressures and subtracting the sensed pressures from each other or sensing the differential pressure directly. Alternatively, a small amount of fluid flows through a differential pressure sensor located on the measurement channel, where the differential pressure sensor directly senses the differential pressure.

The first (or inner) differential pressure is different from the second (or outer) differential pressure, whereby the first (or inner) differential pressure is in particular smaller than the second (or outer) differential pressure. The combination of two different pressure measurement ranges, which at least overlap, with different differential pressures in the measurement channel of the flow sensor increases the resolution and the accuracy over the entire flow measurement range relevant for the measurement and improves the determination of the flow rate in the measurement channel and increases the turndown ratio. Resolution is defined here as the change in pressure difference per change in flow in the measurement channel.

Typically, it is desired that the resolution and accuracy in the entire flow measurement range in the measurement channel is sufficiently large. Two conditions are relevant for this: firstly, the differential pressure at the maximum flow of the fluid should be chosen large enough, and secondly, the laminar part of the measurement should be as large as possible. As a result, the resolution and the differential pressure are greater for small flow rates in the measurement channel. In general, both conditions or effects work against each other. If the differential pressure is increased, primarily only the quadratic part of the differential pressure is increased, which again worsens the ratio of the laminar part to the turbulent part in the measurement. If one now tries to keep the flow more laminar, the total differential pressure is reduced.

Another effect of the quadratic part of the measurement is that the resolution of the calculated flow rate is much greater at high flow rates than at low flow rates. For, with a differential pressure proportional to the flow rate, and a resolution defined as the ratio of the differential pressure and the flow rate, the resolution itself is proportional to the flow rate. Normally, one would like to have a larger absolute resolution at low flow rates or at least the same absolute resolution as at high flow rates.

Instead of one resistance, the measurement channel contains at least two resistances. The differential pressures across the resistive elements are added linearly and the laminar component is increased proportionally to the number of resistive elements. The low flow rates are measured via a differential pressure, in particular via the sum of all differential pressures, and the high flow rates are measured only via individual differential pressures, which are lower, for example. This results in several pressure ranges that can be measured individually. It can be freely selected which flow rate range is measured over how many differential pressure ranges.

The absolute resolution is better distributed over the entire flow measuring range due to the aforementioned method. On the one hand, a high resolution and accuracy is obtained at low flow rates, since the laminar component is large, and on the other hand, a similar resolution is obtained at high flow rates, since measurements are made over fewer differential pressure ranges. In general, any resolution and different turndown ratios can now be produced with the previously mentioned methods, depending on the requirements.

The direction of flow of the fluid through the measurement channel is not relevant, so that the aforementioned method can be used for bidirectional measurements. This means that it is irrelevant from which direction the fluid flows through the measurement channel, the principle works exactly the same. In addition, this measuring method does not show any hysteresis effects in the measurement.

The second (or outer) differential pressure range encloses the first (or inner) differential pressure range in the measurement channel, so that the internal measurement of the first differential pressure is protected by the external measurement of the second differential pressure from external turbulence, which occurs in particular at high flow rates. In addition, the total differential pressure is kept as low as possible.

Preferably, the first (or inner) differential pressure and the second (or outer) differential pressure are measured simultaneously. The pressure is measured at four areas in the measurement channel and the first differential pressure and the second differential pressure are determined. This enables a quick and simplified recording and evaluation of the data of the two differential pressures.

Preferably, the first (or inner) differential pressure area in the measurement channel comprises at least one resistance element, whereby differential pressures are present in the differential pressure range of −20 kPa to 20 kPa. This makes it easy to determine or measure high flow rates in the measurement channel.

In particular, in the first differential pressure range differential pressures from −1.2 kPa to 1.2 kPa, preferably from −0.5 kPa to 0.5 kPa are present. Differential pressure sensors may be provided which measure in this range, whose design is standardised and which can therefore be manufactured at low cost.

Preferably, the second (or outer) differential pressure area in the measurement channel comprises at least two resistance elements, with differential pressures in the differential pressure range from −100 kPa to 100 kPa. This means that smaller flow rates in the measurement channel can be easily determined with the necessary resolution.

In particular, in the second differential pressure range differential pressures from −5 kPa to 5 kPa, preferably from −1.5 kPa to 1.5 kPa are present. Several resistance elements may be provided in the measurement channel, the structure of which is the same and which can thus be manufactured cost-effectively.

Preferably, there are at least three resistance elements in the measurement channel. The more resistance elements are arranged in series in the measurement channel, the more freedom there is for scaling the measurement. The pressure in the pressure difference areas in the measurement channel is determined by the number of resistance elements. In addition, the differential pressure or the pressure drop across a resistance element can be kept smaller if there are several resistance elements in the measurement channel. With a resistance element with a small differential pressure or pressure drop, the laminar component is generally greater, which in turn improves the overall resistance. The first resistance element, as defined here, is the resistance element that is encountered first by the fluid, depending on the flow direction of the fluid. The second resistance element in the measurement channel is therefore encountered by the fluid at a later point in time. The resistance element can be a disc with a number of defined holes, possibly of different sizes, in the disc.

In particular, the first (or inner) or the second (or outer) differential pressure is detected over at least the last resistance element, so that detection of the differential pressure is independent of flow. The laminar part of the flow increases the more resistance elements are arranged in series in the measurement channel. The flow will therefore have the largest laminar part over the last resistance element. This improves the resistance characteristic of the last resistance element compared to the second resistance element. An improved resistance characteristic leads to a further improvement in resolution.

In particular, at least one resistance element is constructed differently from another resistance element. The exact differential pressure ranges can be designed individually, whereby the maximum differential pressure and the resolution in each differential pressure range are adjusted individually.

Preferably, the first (or inner) differential pressure in the measurement channel is detected over the second resistance element or is detected over the second and the third resistance element. In this way, the measurement of the first differential pressure, i.e. the internal measurement, is protected by the external resistance elements, so that turbulence can be prevented, especially at high flow rates, and thus the accuracy of the measurement process is further improved.

In particular, the second (or outer) differential pressure in the measurement channel is detected over all three resistance elements.

Preferably, there is a memory unit in which at least one first threshold value for the first (or inner) differential pressure is stored. The at least one first threshold value serves as a definition criterion for the detection of the second differential pressure in the second (or outer) differential pressure range. If the at least first threshold value for the first differential pressure is reached, it can be automatically determined whether or how the second differential pressure is measured. A simple switching of the measurements between the first and second differential pressures is possible depending on the level of the flow rate.

Alternatively, or additionally, at least one first threshold value for the second differential pressure is stored in the memory unit. This at least one first threshold value serves as a definition criterion for the detection of the second differential pressure in the second differential pressure range. If the at least first threshold value for the second differential pressure is reached, switching between the measurements can take place depending on the flow rate.

Preferably, at least one threshold value is retrieved from the memory unit and compared in an evaluation unit with at least one of the two detected differential pressures. The evaluation unit can independently recognise at which flow rate a switchover of the measuring ranges is necessary.

Preferably, the first threshold value of the first differential pressure is compared with the currently detected first differential pressure. The measurement procedure can be shortened if the desired resolution is already sufficient at the present flow rate. In particular, step c. is carried out if the first threshold value is greater than the currently detected first differential pressure.

Preferably, at least one differential pressure sensor is provided, wherein the at least one differential pressure sensor measures the first (or inner) differential pressure and the second (or outer) differential pressure and the measurement range of the at least one differential pressure sensor for the second differential pressure is smaller than the measurement range of the at least one differential pressure sensor for the first differential pressure.

Alternatively, a second differential pressure sensor is provided, wherein the at least one differential pressure sensor (inner) measures the first differential pressure in the first differential pressure range and the second differential pressure sensor (outer) measures the second differential pressure in the second differential pressure range, wherein the measuring range for the first differential pressure sensor (inner) is larger than the measuring range of the second differential pressure sensor (outer). This additionally increases the resolution and thus the accuracy for small flow rates.

Preferably, the measurement range of the at least one differential pressure sensor (inner) is in the range from −20 kPa to 20 kPa, in particular −1.2 kPa to 1.2 kPa, preferably from −0.5 kPa to 0.5 kPa.

Preferably, the measuring range of the second differential pressure sensor (outer) is in the range of −2.5 kPa to 2.5 kPa, in particular −0.5 kPa to 0.5 kPa, preferably −0.125 kPa to 0.125 kPa.

Preferably, at least one fluid property of the fluid in the measurement channel is detected and used in step e) to determine the flow rate in the evaluation unit. This further improves the determination of the flow rate with the desired accuracy, since this depends not only on the geometry in the measurement channel, but also on the fluid properties themselves.

In particular, the fluid property is recorded with the help of a user and/or measured with a sensor and/or calculated in the evaluation unit. In this way, the process can be further improved with empirical values, e.g. for a certain fluid type. For example, the fluid properties are stored as parameters in a lookup table in the evaluation unit and can thus be easily calculated as a function of the user inputs or as a function of (other) fluid properties measured by the sensor. In this way, the fluid properties are directly available to the process, so that a fast and cost-effective measurement process can be carried out.

Preferably, the fluid property is comprised of at least one parameter from the group of absolute pressure, temperature, humidity, fluid type, viscosity, and density. These can be used individually, or in combination, directly to determine the flow rate, so that the accuracy in the measurement procedure is increased and, in particular, the conversion to different flow rate measurement standards can take place. The parameters of the fluid properties are mapped via at least one mathematical function, for example a polynomial, and can be taken into account when determining the flow rate.

A flow sensor according to the invention for determining a flow rate of a fluid in a measurement channel, in particular by means of the method described above, comprises a measurement channel with at least three channel sections which are arranged in series adjacent to one another in the flow sensor, and at least one resistance element is arranged between each of the channel sections adjacent to one another, each of the three channel sections having at least one measurement connection for measuring a fluid pressure.

At least two channel sections define the first (or inner) differential pressure range and at least three channel sections define the second (or outer) differential pressure range. Each differential pressure in the measurement channel is generated by means of at least one resistance element in the measurement channel as described above. The first (or inner) differential pressure is different from the second (or outer) differential pressure, whereby the first differential pressure is in particular smaller than the second differential pressure. The combination of two different measurement ranges with different differential pressures in the measurement channel of the flow sensor increases the resolution over the entire measurement range relevant for the measurement and improves the determination of the flow rate in the measurement channel. An optimal resistance element has as large a laminar resistance component as possible. This is desired so that the absolute resolution is as large as possible for small flow rates.

The absolute resolution of the measurement is better distributed over the entire measuring range due to the aforementioned geometry of the flow sensor. On the one hand, a high resolution is obtained at low flow rates, since the laminar component is large, and on the other hand, a similar resolution is obtained at high flow rates, since measurements are made over fewer differential pressure ranges. In general, with the flow sensor disclosed here and the previously mentioned method, any resolution can now be set when determining the flow rate, depending on the requirements. Furthermore, the flow sensor has no moving parts, so that it is robust and durable and can be miniaturised.

Arranging the resistance elements in series results in an advantageous addition of the resistance values, whereby the ratio of the linear flow part to the quadratic flow part remains the same. That is, the resistance retains the desired ratio and the total resistance becomes greater.

Preferably, there is at least one housing component in which the three channel sections are configured. The housing component may be easily manufactured using additive manufacturing processes and comprises both the at least three channel sections and the resistance elements that may be permanently installed therein. Thus, the flow sensor can be manufactured simply and inexpensively. In addition, the manufactured flow sensors have comparable characteristics, so that a subsequent adjustment of the geometry is not necessary.

Preferably, a sieve is arranged in the first channel section so that the measurement of the flow rate is not disturbed by unwanted foreign bodies or preceding turbulence. In particular, another sieve is also arranged in the last channel section. The measurement channel is thus bidirectionally protected.

Preferably, there are at least two housing components in each of which at least one of the three channel sections is configured. This provides a simple housing with few components with defined differential pressure ranges, whereby a reproducible detection of the first and the second differential pressure is possible.

Preferably, the resistance elements are exchangeably arranged in the measurement channel. This makes it easy to manufacture the housing, for example, and depending on the application of the flow sensor, different resistance elements can be easily arranged in the measurement channel, for example, in order to adapt the resolution in the measurement method to the type of fluid. In particular, defective resistance elements can be easily replaced, which means that the flow sensor can be used for different applications, thus protecting the environment.

Preferably, at least one resistance element is configured differently from another resistance element. This means that the laminar or turbulent flow part can be adapted depending on the type of fluid used.

Preferably, at least one differential pressure sensor is arranged at at least two of the measurement connections. The measurement connections can project from the pressure measurement sensor or run as a spur line into the measurement channel so that the differential pressure sensor is also located in the measurement channel and/or is arranged outside the measurement channel. The differential pressure sensor can have at least four pressure measurement connections for detecting the first (or inner) differential pressure and for detecting the second (or outer) differential pressure, which may be connected directly or indirectly to the measurement connections. In particular, a further differential pressure sensor is present, wherein the at least one differential pressure sensor is directly or indirectly connected to two measurement connections of the flow sensor and the further differential pressure sensor is connected to two further measurement connections of the flow sensor.

Preferably, at least one absolute pressure sensor and/or one temperature sensor and/or one humidity sensor is present in the measurement channel. This allows further fluid properties to be measured and allows the accuracy of the flow rate determination to be improved, as well as allows the conversion to different flow rate measurement standards to be possible.

A measurement system according to the invention for determining a flow rate with a flow sensor, in particular with a flow sensor as described above, and with at least one differential pressure sensor comprises an evaluation unit which is connected at least to the at least one differential pressure sensor in order to detect at least a first (or inner) differential pressure in the measurement channel of the flow sensor and to detect a second (or outer) differential pressure in the measurement channel of the flow sensor. The differential pressure sensor is thus arranged between the measurement connections of the flow sensor and the evaluation unit, this being at least from an electrotechnical point of view—in particular if the differential pressure sensor is arranged in the measurement channel of the flow sensor. In particular, the evaluation unit is configured to carry out the aforementioned method. The absolute resolution is better distributed over the entire measuring range due to the aforementioned method. On the one hand, a high resolution and accuracy is obtained at low flow rates, since the laminar flow part is large, and on the other hand, a similar resolution is obtained at high flow rates, since measurements are made over fewer differential pressure ranges. In general, any resolution can now be achieved with the aforementioned measurement system, depending on the requirements.

Preferably, a display unit is provided to display at least the flow rate, so that a direct readout of the measured flow rate and/or the other aforementioned fluid properties is possible on the measurement system.

In particular, the flow rate can be displayed graphically, so that, for example, the flow rate can be displayed over time.

Preferably, a memory unit is provided in which at least a first threshold value is stored. This means that the at least first threshold value described above can be retrieved easily and reproducibly and can be used in the evaluation unit.

Alternatively, or additionally, there is at least one interface for reading out recorded values of the differential pressures or flow rates. The recorded values can thus be transmitted to an external evaluation device. The interface can be a wireless or wire-based interface, so that a physical connection of the measurement system to the external evaluation device can be dispensed with if necessary. Alternatively, or additionally, an interface is available for reading out evaluated data.

A differential pressure sensor according to the invention for a flow sensor, in particular a flow sensor as previously described, comprises four pressure measurement connections for detecting two different differential pressures in a measurement channel. Such a differential pressure sensor requires only one power supply, only one housing and is thus simple and inexpensive to construct. The necessary readout protocol can be kept simple and only one interface, for example a data bus, is necessary, so that the installation and maintenance of the differential pressure sensor is simplified.

Preferably the measuring range (inner) is in the range of −20 kPa to 20 kPa, especially in the range of −1.2 kPa to 1.2 kPa, preferably from −0.5 kPa to 0.5 kPa.

Preferably the measuring range (outer) is in the range of −2.5 kPa to 2.5 kPa, especially in the range of −0.5 kPa to 0.5 kPa, preferably from −0.125 kPa to 0.125 kPa.

Further advantages, features and details of the invention will be apparent from the following description, in which embodiments of the invention are described with reference to the drawings.

The list of reference signs as well as the technical content of the patent claims and figures are part of the disclosure. The figures are described coherently and comprehensively. Identical reference signs indicate identical components, reference signs with different indices may indicate functionally identical or similar components.

### BRIEF DESCRIPTION OF THE DRAWINGS

The figures show:

FIG. 1A schematic sectional view of a flow sensor according to the invention,

FIG. 2A schematic side view of a measurement system according to the invention with a flow sensor according to FIG. 1,

FIG. 3A further schematic side view of the measurement system according to FIG. 2,

FIG. 4 a flow chart of a method according to the invention with a measurement system according to FIG. 2 or FIG. 3, and

FIG. 5 a differential pressure sensor according to the invention for a flow sensor according to FIG. 1.

FIG. 6 a schematic representation of the differential pressure (dP) measurement values as a function of the flow rate (F)

### DETAILED DESCRIPTION OF THE INVENTION

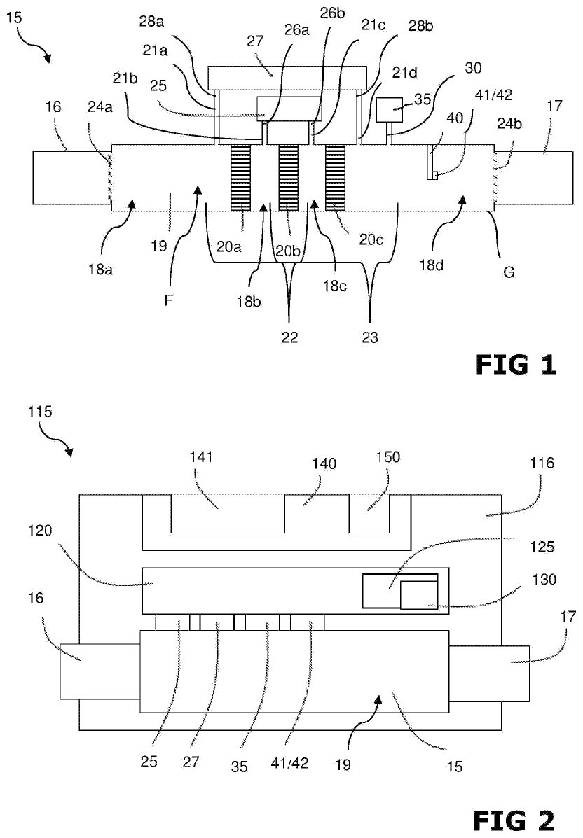

FIG. 1 shows a flow sensor 15 with a housing component G for determining a flow rate of a fluid F in a measurement channel 19. The flow sensor 15 has a first connection 16 and a second connection 17 for connecting fluid tubes, the measurement channel 19 extending between the first and second connections 16, 17. Sieves 24a, 24b are arranged at the two connections 16, 17 to protect the measurement channel from foreign bodies and to calm the flow of the fluid so that a reproducible measurement is possible. The measurement channel 19 has four channel sections 18a-18d, which are arranged in series adjacent to each other in the flow sensor 15, and at least one resistance element 20a-20c is arranged in series between each of the channel sections 18a-18d adjacent to each other. The flow sensor 15 has a first differential pressure region 22 and a second differential pressure region 23. The first differential pressure region 22 may also be referred to as the inner differential pressure region and comprises the two channel sections 18b and 18c, as well as the resistance element 20b. The second differential pressure region 23 may also be referred to as the outer differential pressure region and comprises the four channel sections 18a-18d, as well as the resistance elements 20a-20c. Each of the channel sections 18a-18d has a measurement connection 21a-21d for measuring a fluid pressure of the fluid F flowing through the measurement channel.

A first (or inner) differential pressure sensor 25 is arranged at the measurement connections 21b and 21c. The measurement connections 21b and 21c project from the flow sensor 15. The differential pressure sensor 25 has two pressure measurement connections 26a and 26b and detects the first differential pressure in the first differential pressure region 22. The measuring range of the first differential pressure sensor 25 is in the range from −0.5 kPa to 0.5 kPa.

A second (or outer) differential pressure sensor 27 is arranged at the measurement connections 21a and 21d on the flow sensor 15. The measuring range of the second differential pressure sensor 27 is in the range of −0.125 kPa to 0.125 kPa. The measurement connections 21a and 21d project from the flow sensor 15. The differential pressure sensor 27 has two pressure measurement connections 28a and 28b and detects the second differential pressure in the second differential pressure region 23.

The first (or inner) differential pressure is measured via the measurement connections 21b and 21c and the second (or outer) differential pressure is measured via the measurement connections 21a and 21d. The first differential pressure is different from the second differential pressure, whereby the first differential pressure is in particular smaller than the second differential pressure.

The flow sensor 15 has a further measurement connection 30, which projects from the housing component G and is arranged on the duct or channel section 18d. An absolute pressure sensor 35 is arranged at this measurement connection 30, which measures the absolute pressure in the fluid. The absolute pressure sensor has a measuring range of 0.5 to 2 mbar.

The flow sensor 15 may have a holding device 40, which is arranged in the channel section 18d. A temperature sensor 41 and a humidity sensor 42 may be arranged on this holding device 40, which measure the temperature and the humidity in the fluid. These sensors are arranged in the measurement channel 19 via a holding device 40 and are electrically connectable to an evaluation unit, as shown below.

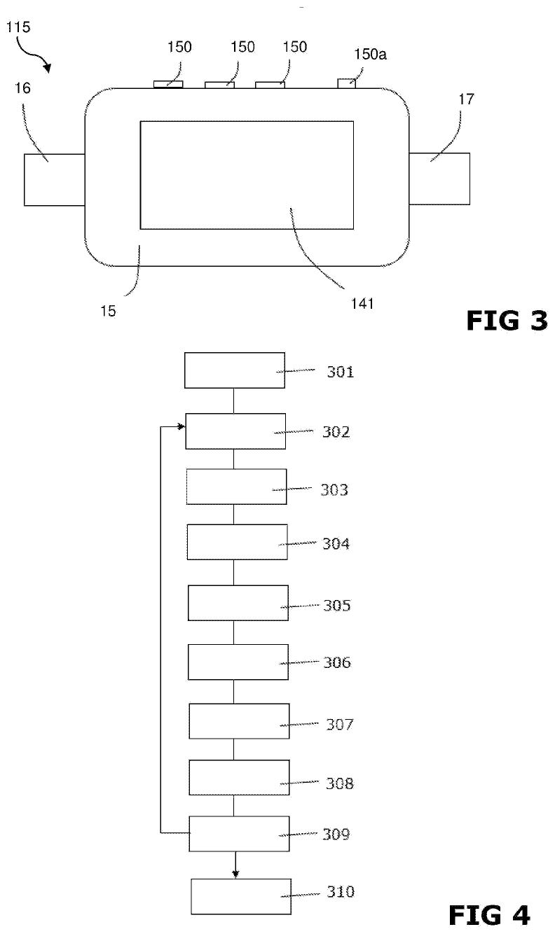

FIG. 2 and FIG. 3 show a measurement system 115 for determining a flow rate with the flow sensor 15 in a housing 116, as previously described in accordance with FIG. 1. The differential pressure sensors 25 and 27, the absolute pressure sensor 35, the temperature sensor 41 and the humidity sensor 42 are electrically connectable to an evaluation unit 120 for exchanging the respective measurement data. The evaluation unit 120 is thus connectable to the differential pressure sensors 25 and 27 to detect the first (or inner) differential pressure in the measurement channel 19 of the flow sensor 15 and to detect the second (or outer) differential pressure in the measurement channel 19 of the flow sensor 15. The differential pressure sensors 25 and 27 are thus arranged between the measurement connections 21a-21d of the flow sensor 15 and the evaluation unit 120. The evaluation unit 120 has a memory unit 125 and a computing or processing unit 130. Various mathematical functions (polynomials, lookup tables) for the temperature, the humidity for different fluid types as well as various threshold values for the differential pressures are stored in the memory unit 125. The computing unit 130 is connected to the memory unit 125 for the exchange of data, whereby the recorded differential pressures and the method described below is carried out in the computing unit 135 of the evaluation unit 12.

A display unit 140 may be provided to display at least the determined flow rate and/or the measured parameters of the temperature sensor 41, the humidity sensor 42 and/or the absolute pressure sensor 35. The display unit may comprise a simple display and input buttons or comprise a touch display 141 to select individual programmes, functions or data. The display may be configured to graphically show the flow rate.

The measurement system may show several interfaces 150 for reading out recorded values or data of the differential pressures. The recorded values can thus be transmitted to an external evaluation device. The interfaces shown are USB interfaces and RS232 interfaces. At least one interface 150a is a wireless interface, such as Bluetooth®.

FIG. 4 shows a flow diagram comprising a method for determining the flow rate, wherein with regard to the device features reference is made to the measurement system 115 in accordance with FIG. 2 and FIG. 3.

The method for determining a flow rate of a fluid through a flow sensor 15 having a measurement channel 19, comprises at least the following steps:
Providing a fluid in the measurement channel 19 of the flow sensor 15 (step 301);
Detecting at least one first (or inner) differential pressure in the measurement channel 19, the at least one first differential pressure being present in a first differential pressure region 22 in the measurement channel 19 (step 302);
Detecting at least one second differential pressure in the measurement channel 19, the at least one second differential pressure being present in a second (or outer) differential pressure region 23 in the measurement channel 19 and the differential pressure in the second differential pressure region 23 encompassing the differential pressure in the first differential pressure region 22 (step 303);
Transmitting the detected differential pressures to an evaluation unit 120;
Detecting the temperature and/or the humidity with the temperature sensor 41 (step 304);
Detecting the absolute pressure with the absolute pressure sensor (step 305);
Determining the density or viscosity which is a function of the fluid type, temperature, humidity and absolute pressure (step 306);
Determining a first flow rate based on the first differential pressure determination in the first differential pressure region 22, the density and the viscosity in the computing unit of the evaluation unit 120 (step 307);
Determining a second flow rate on the basis of the second differential pressure determination in the second differential pressure region 23, the density and the viscosity in the calculation unit of the evaluation unit 120 (step 308);
Determining the flow rate in the measurement channel 19 with the aid of the evaluation unit 120 on the basis of the detected differential pressures or the first and second flow rate determined therefrom (step 309).

When providing the fluid, a fluid type is selected in the evaluation unit (step 301). The fluid type is selected by a user on the display and entered using the input buttons. The fluid type is stored in a lookup table in the memory unit of the evaluation unit 120.

The differential pressures in the measurement channel 19 are created using the resistance elements 20a-20c in the measurement channel 19, and are measured directly by the differential pressure sensors 25, 27. The first (or inner) differential pressure is different from the second (or outer) differential pressure, whereby the first differential pressure is in particular smaller than the second differential pressure. The second differential pressure area 23 encompasses the first differential pressure area 22 in the measurement channel 19, so that the internal measurement of the first differential pressure is protected by the external measurement of the second differential pressure from external turbulence, which arises in particular at high flow rates.

In the first (or inner) differential pressure region 22 in measurement channel 19, first differential pressures in the differential pressure range from −0.5 kPa to 0.5 kPa are recorded. In the second (or outer) differential pressure region 23 in measurement channel 19, second differential pressures in the differential pressure range from −1.5 kPa to 0.5 kPa are recorded.

Prior to step 302, a first threshold value can be retrieved from the memory unit 125 in the computing unit 130, which serves as a determination criterion for the detection of the second differential pressure in the second differential pressure range 23. If the at least first threshold value for the first differential pressure is reached, it can be automatically determined whether or how the second differential pressure is measured. The first threshold value of the first differential pressure is compared in the computing unit with the currently detected first differential pressure.

Steps 302 to 309 may be performed several times before a flow rate is displayed on the display unit 140 (step 310).

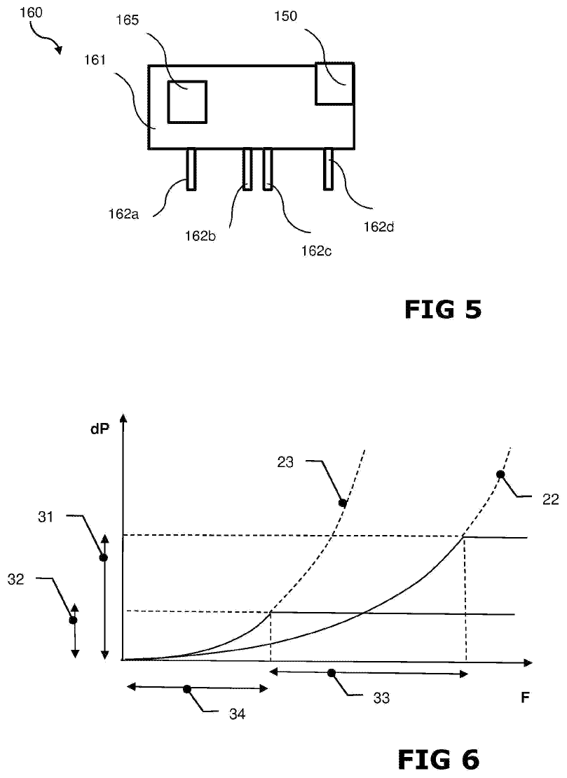

FIG. 5 shows a differential pressure sensor 160 for a flow sensor 15 in accordance with FIG. 1, which comprises four pressure measurement connections 162a-d for detecting two different differential pressures in a measurement channel 19. The differential pressure sensor 160 requires only one power supply 165, only one housing 161 and is therefore simple and inexpensive to construct. The necessary readout protocol can be kept simple and only one interface 150, for example a data bus, is necessary, so that the installation and maintenance of the differential pressure sensor is simplified.

The first (or inner) measuring range of the differential pressure sensor 160 is in the range of −0.5 kPa to 0.5 kPa. The second (or outer) measuring range of the differential pressure sensor 160 is in the range from −0.125 kPa to 0.125 kPa.

FIG. 6 shows a schematic representation of the differential pressure (dP) measurement values as a function of flow rate (F). In a high flow rate range 33 (typically up to 300 liters per minute), the first (or inner) differential pressure sensor 25 determines a differential pressure in the first differential pressure range 22. In a low flow rate range 34 (typically up to 60 liters per minute), the second (or outer) differential pressure sensor 27 determines a differential pressure in the second differential pressure range 23. In the embodiment shown, the second pressure measurement range 32 (typically 0.125 kPa) of the second differential pressure sensor 27 is smaller than the first pressure measurement range 31 (typically 0.5 kPa) of the first differential pressure sensor 25.

The measured values shown in FIG. 6 are representative of an asymmetric sensor (flow in one direction). The method according to the invention is also applicable for bidirectional measurements into a symmetrical sensor. Reversing the flow direction results in measurement values that are mirrored in the origin compared to FIG. 6. In a symmetrical sensor, the first pressure measurement range 31 is typically −0.5 kPa to 0.5 kPa, and the second pressure measurement range 32 is typically −0.125 kPa to 0.125 kPa.

### LIST OF REFERENCE SIGNS

15 Flow sensor
16 First connection
17 Second connection
18a-18d Duct or Channel sections
19 Measurement channel
20a-20d Resistance elements
21a-21d Measurement connection
22 First or inner differential pressure range
23 Second or outer differential pressure range
25 First or inner differential pressure sensor
26a-26b Pressure measurement connections
27 Second or outer differential pressure sensor
28a-28b Pressure measurement connections
30 Measurement connection
31 Pressure measuring range first or inner differential pressure sensor
32 Pressure measuring range second or outer differential pressure sensor
33 high flow rate range
34 low flow rate range
35 Absolute pressure sensor
40 Holding device
41 Temperature sensor
42 Humidity sensor
115 Measurement system
116 Housing
120 Evaluation unit
125 Memory unit
130 Computing or Processing unit
140 Display unit
141 Touch display
150-150a Interfaces
160 Differential pressure sensor
161 Housing
162a-162d Pressure measurement connections
165 Power supply
301-310 Process/method steps
G Housing component
F Fluid (gas/liquid)

1. A method for determining a flow rate of a fluid through a flow sensor (15) having a measurement channel (19), in particular a flow sensor for testing a respirator, the method comprising at least the following steps:
a. providing a fluid in the measurement channel (19) of the flow sensor (15), wherein three resistive elements (20a-20c) are present in the measurement channel (19);
b. detecting at least one first differential pressure in the measurement channel (19), wherein the at least one first differential pressure is present in a first differential pressure range (22) in the measurement channel (19), and wherein the first differential pressure is detected over the second resistance element (20b), or is detected over the second and third resistance elements (20b, 20c);
c. detecting at least one second differential pressure in the measurement channel (19), wherein the at least one second differential pressure is present in a second differential pressure region (23) in the measurement channel (19) and the differential pressure in the second differential pressure region (23) encompasses the differential pressure in the first differential pressure region (22);
d. transmitting the detected differential pressures to an evaluation unit (120);
e. determining a flow rate in the measurement channel (19) with the evaluation unit (120) on the basis of the detected differential pressures.

2. The method according to claim 1, wherein the detecting of the first differential pressure and the second differential pressure takes place simultaneously.

3. The method according to claim 1, wherein the first differential pressure region (22) in the measurement channel (19) comprises at least one resistance element (20a-20c), and wherein the differential pressures being present range from −20 kPa to 20 kPa, in particular −1.2 kPa to 1.2 kPa, preferably from −0.5 kPa to 0.5 kPa.

4. The method according to claim 1, wherein the second differential pressure region (23) in the measurement channel (19) comprises at least two resistance elements (20b, 20c), and wherein differential pressures being present range from −100 kPa to 100 kPa, in particular −5 kPa to 5 kPa, preferably from −1.5 kPa to 1.5 kPa.

5. The method according to claim 1, wherein the second differential pressure is detected over all three resistance elements (20a-20c).

6. The method according to claim 1, wherein a memory unit (125) is present in which at least a first threshold value for the first differential pressure is stored and/or at least a first threshold value for the second differential pressure is stored.

7. The method according to claim 1, wherein at least one differential pressure sensor (25, 27) is present which is arranged to measure the first differential pressure and the second differential pressure, or wherein preferably a second differential pressure sensor is present, wherein the at least one differential pressure sensor is arranged to measure the first differential pressure and the second differential pressure sensor is arranged to measure the second differential pressure, wherein the measurement range for the first differential pressure is greater than the measurement range for the second differential pressure.

8. The method according to claim 1, wherein at least one fluid property of the fluid is detected in the measurement channel (19) and is used in step e) when determining the flow rate, the fluid property being detected with the aid of a user and/or being measured with a sensor and/or being calculated in the evaluation unit (120), and preferably the fluid property being comprised of at least one parameter from the group of absolute pressure, temperature, humidity, fluid type, viscosity, and density.

9. A flow sensor for determining a flow rate of a fluid in a measurement channel (19), with the method according to claim 1, wherein the measurement channel (19) comprises at least four channel sections (18a-18d), which are arranged in series adjacent to one another in the flow sensor (15) and at least one resistance element (20a-20c) is arranged between each of the channel sections (18a-18d) adjacent to one another, wherein each of the channel sections (18a-18d) has at least one measurement connection (21a-21d) for measuring a fluid pressure.

10. The flow sensor according to claim 9, wherein at least one housing component is present in which the four channel sections (18a-18d) are formed, and wherein preferably a sieve (24a) is arranged in the first channel section (18a).

11. The flow sensor according to claim 9, wherein the resistance elements (20a-20c) are arranged interchangeably in the measurement channel (19), and preferably at least one resistance element (20b) is configured differently from the other resistance elements (20a, 20c).

12. The flow sensor according to claim 9, wherein at least one differential pressure sensor (25, 27) is arranged on at least two of the measurement connections (26a, 26b, 28a, 28b) and preferably at least one absolute pressure sensor (35) and/or one temperature sensor (41) and/or one humidity sensor (42) is present in the measurement channel (19).

13. A measurement system (115) for determining a flow rate with the flow sensor according to claim 9, and with at least one differential pressure sensor (25, 27), wherein an evaluation unit (120) is provided which is connected at least to the at least one differential pressure sensor (25, 27), in order to detect at least a first differential pressure in the measurement channel (19) of the flow sensor (15) and to detect a second differential pressure in the measurement channel (19) of the flow sensor (15), the evaluation unit (120) being configured to carry out a method for determining the flow rate of a fluid through the flow sensor (15), and there being preferably a display unit (120) in order to display at least the flow rate, it being possible in particular to display the flow rate graphically.

14. The measurement system according to claim 13, wherein a memory unit (135) is present in which at least a first threshold value is stored and/or at least one interface is present for reading out recorded values and/or evaluated data.

15. A differential pressure sensor (160) for a flow sensor (15) according to claim 9, having four pressure measurement connections (162a-162d) for detecting two different differential pressures in a measurement channel (19).
